(19) United States
(12) Patent Application Publication
(10) Pub. No.: US 2004/0249833 A1
(43) Pub. Date: Dec. 9, 2004

(54) Copying method and system for copying cells in a database

(76) Inventor: Kenneth Oksanen, Helsinki (FI)

Correspondence Address: Robert M Bauer, Brown Raysman Millstein Felder & Steiner, 900 Third Avenue, New York, NY, 10022, US

(21) Appl. No.: 10/482,613

(22) PCT Filed: Jun. 25, 2001
(86) PCT No.: PCT/EP01/07196

(51) Int. Cl. G06F 17/00

(52) U.S. Cl. 707/100

(57) ABSTRACT

A method for copying cells in a database which are referred to by pointers comprises the steps of: probe if a cell identical to a cell to be copies is stored in a cache memory, and if such an identical cell is found in said cache, instead of copying the content of the cell, redirecting the pointer referring to said cell to be copied to said identical cell. Also an apparatus for storing and processing a database according to this method is described.

### FIELD OF THE INVENTION

The present invention relates to a method and system for copying cells in a database, and more specially to a database in which at least one generation is copied to form a new major generation.

### BACKGROUND OF THE INVENTION

A known database consists of a large amount of data which is stored in a persistent memory such as a hard disk medium. If the structure of the database given by pointers stored in the cells of the database and pointers stored in the root block of the database is only stored in the persistent memory, every access to data consumes a large amount of input output (IO) time. Hence, at least the structure of the database given by said pointers is stored in a fast accessible memory, for example a dynamic random access memory.

In the database, cells are arranged into different generations, whereby a pointer stored in a cell of a generation refers either to a cell in the same generation or to a cell in an older generation. If a link to a specific cell is no longer needed, the pointer referring to this cell is deleted or set to NIL. This can be done in the transient memory, so that no disk IO is needed. Also, the cell could be referred to by another pointer so that before checking for this the memory pages of this cell cannot be freed. But due to this, if a cell is no longer referred by any pointer, the memory pages remain allocated and useless data consumes memory space on the hard disk memory.

Hence, after the replication has run for a while, a lot of cells which are not referred to by any pointer consume a lot of space of the database, those cells are called garbage cells or for short garbage. Therefore, a garbage collection occurs, and at least one generation is collected into a new major generation, whereby garbage cells, because they are no longer referred to by a pointer, are omitted, and after the garbage collection is finished, the memory pages of the generations collected are freed. Thereby, the garbage of the database is removed, and the entire space needed for the whole database is reduced.

While the garbage collection occurs, care must be taken to fulfill the requirements for a recovery procedure, in case the database crashes, for example due to a power failure, before the new major generation as well as the updated pointers as a whole have been written to disk. For this propose, each step of the garbage collection can be instantaneously written into a garbage collection protocol stored on a persistent memory, such as a hard disk medium.

The known database has many disadvantages. The known garbage collection halts the execution of the application for the entire duration of the collection, and due to the frequent disk IO, this takes a long time. For example, for a 200 MB semispace this would require somewhere from 5 to 10 seconds of CPU-work and tens of seconds, perhaps even a minute, of disk IO. Also, the need for a recovery requires that the memory pages of the generations collected can be freed after the new major generation as well as the pointers belonging to it have been written to disk at the earliest. Hence, in a garbage collection almost the memory space required by the generations to be collected must be allocated, so that just before the new major generation has been written to disk, almost twice the memory of the generation collected is consumed.

On the other hand, a lot of cells comprise the same content. For example, in a database in which address data is stored, the name “Smith, John” or the city “Helsinki” is stored in a lot of different cells, so that a lot of disk memory is occupied by storing many times the same content. For this reason, the known database comprises a lot of redundant data.

### SUMMARY OF THE INVENTION

It is an object of the present invention to provide a method and apparatus to reduce the memory space utilized by a database.

This object is achieved by a method for copying cells in a database, which cells are referred to by pointers, comprising the steps of:

probe if a cell identical to a cell to be copied is stored in a cache memory, and if such an identical cell is found in cache, instead of a copying the content of the cell redirecting the pointer referring to said cell to be copied to that identical cell.

Furthermore, the above object is achieved by an apparatus for storing and processing a database which comprises:

a persistent storage means for storing at least one generation of the database, whereby each generation comprises at least one cell, the pointers stored in the cell of the major generations of the database, and the pointers stored in the root block of the database,

a transient memory for storing copies of pointers referring to the cells of the generations of the database, whereby those pointers are temporarily updated only in said transient memory,

a cache stored in said transient memory in which at least a few of the cells are stored which have been recently copied,

whereby, in case a cell of one of the generation is copied into a new major generation, it is probed if a cell which is identical to said cell to be copied is stored in said cache, and if such a identical cell is found in cache, the pointer referring to said cell to be copied is redirected to the address of said identical cell, and a forwarding address from the new major generation to said identical cell is allocated.

The present invention has the advantage, that every time a cell is copied, it is probed, if an identical cell is stored in the cache memory, so the total size of the database can be reduced by merging cells with identical content. Searching for identical cells is performed very frequently, namely, each time a cell is copied in the garbage collection. To make sure not to increase the duration of a garbage collection step excessively, according to an advantageous development, the cache is built up by a hash table of limited size. Hence, it is not guaranteed that all identical cells are combined, but a cache of, for example, a few hundred or thousand recently copied cells suffices to reach hit ratios not significantly less than an otherwise impractically slow and large index of all cells in the database. Thereby, to decrease the probing time it is advantageous to probe first for a matching of the hash code of the cells, so that the comparison does not have to be performed for entire cell contents. Only if there is a matching in the hash code between the cells, then a bytewise comparison of the contents of the cells is required.

According to an advantageous development, if the content of a cell is copied to a new cell, a forwarding address to the new cell is stored in that cell copied, and, if a cell, because being referred to by a further pointer, is copied, in which cell a forwarding address is stored, instead of copying the content of said cell, said further pointer referring to said cell is updated to the forwarding address. Therefore, if a cell is referred to by two or more pointers, and due to the merging of cells with identical content this is often the case, a splitting of the cell in two or more new cells is prevented, and, because the probe, whether a forwarding address is stored in the cell to be copied, precedes probing for an identical cell stored in cache, the performance of the copying, and hence the garbage collection, is increased.

### BRIEF DESCRIPTION OF THE DRAWINGS

In the following, the present invention will be described in greater detail based on preferred embodiments with reference to the accompanying drawing figures, in which:

FIG. 1 shows the beginning of a major collection according to a preferred embodiment of the invention;

FIGS. 2 and 3 show the procedure of a major collection step according to the preferred embodiment;

FIG. 4 shows a first generation collection according to the preferred embodiment;

FIG. 5 shows a procedure to drain the copy stack according to the preferred embodiment;

FIG. 6-8 show a procedure for copying cells in the database according to the preferred embodiment;

FIG. 9-13 show a first example of a database during a major generation garbage collection;

FIG. 14 shows the reconstruction of said first example database according to the preferred embodiment of the invention;

FIGS. 15 and 16 show a second example of a database during a major generation garbage collection according to the preferred embodiment of the invention; and

FIG. 17 shows an apparatus for storing and processing a database according to the preferred embodiment.

### DESCRIPTION OF THE PREFERRED EMBODIMENTS

The preferred embodiment of the present invention will now be described with reference to the accompanied figures.

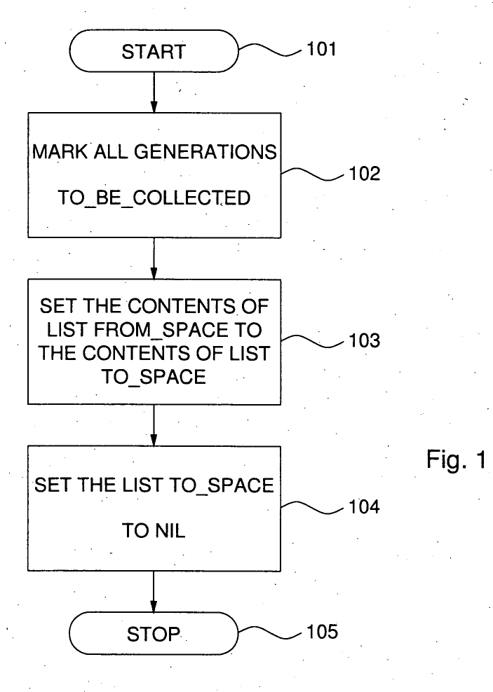

FIG. 1 shows a procedure performed in the beginning of a collection of the generations of the database to free up pages of memory space. The database of the preferred embodiment comprises two lists, the FROM_SPACE list and the TO_SPACE list. The FROM_SPACE list comprises the generations marked TO_BE_COLLECTED, because they are collected during the major collection procedure, and the TO_SPACE list comprises the generations marked NORMAL, because they are new generations which are already collected or should not be collected during the major collection procedure. In the database of the preferred embodiment new data is inserted at the end of TO_SPACE, therefore a root pointer pointing to the last element of TO_SPACE is stored in the root block of the database. Each of the lists FROM_SPACE and TO_SPACE is ordered according to age from the youngest to the oldest generation.

When a major collection is started in step 101, all generations of the database are marked TO_BE_COLLECTED in step 102, as shown in FIG. 1. Thereafter in step 103 the contents of the FROM_SPACE list is set to the contents of the TO_SPACE list, thereby fromspace and tospace are swapped. Hence, after step 103 the list TO_SPACE can be set to NIL in step 104 without losing data, because all data it saved in FROM_SPACE in step 103. Thereafter, the procedure is finished in step 105.

After the procedure shown in FIG. 1 which is processed in the beginning of a major collection of the generations of the database is finished in step 105, it is already possible to add new data to the database. Such new data is stored in a new generation stored in TO_SPACE and marked NORMAL. Hence, after the short time needed for flipping fromspace and tospace, as described according to FIG. 1, the application is ready for new jobs.

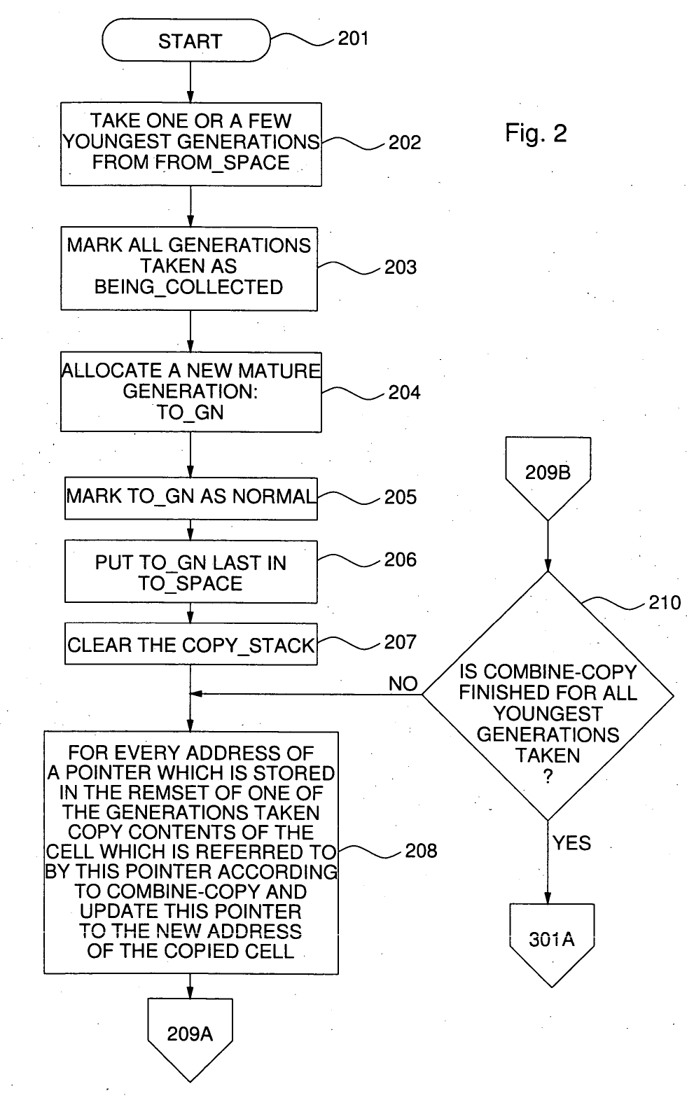

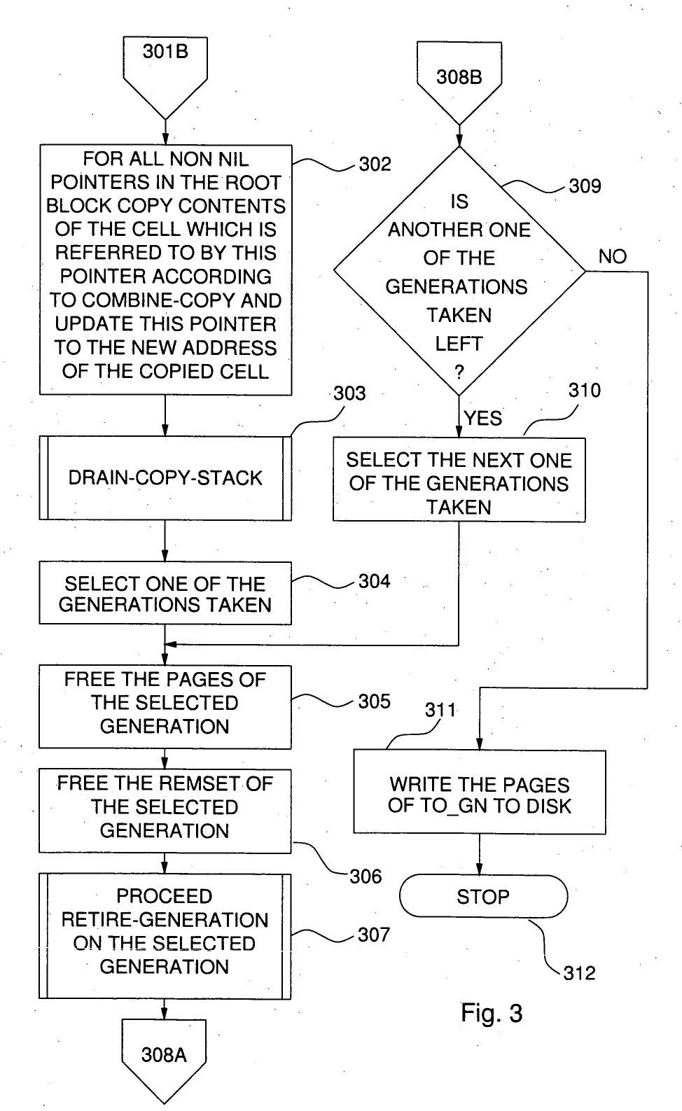

The generations marked TO_BE_COLLECTED are collected from the youngest to the oldest generation. Thereby, in each major collection step one or a few generations can be collected into a new major generation allocated in tospace, as now described in greater detail with reference to FIGS. 2 and 3.

One, a few or all of the remaining generations marked TO_BE_COLLECTED can be collected in a major collection step, depending on the size of the generations and the utilization of the application. After starting the major collection step in step 201, in step 202 one or a few youngest generations are taken from fromspace and marked as BEING_COLLECTED in step 203. If two successive generations from fromspace are sufficently small, they are always both selected in step 202, to keep the number of major generation from growing unlimited. Thereby, the amount of metadata of the database is kept small compared to the data stored.

In step 204 a new mature generation TO_GN is allocated from the transient memory, and in step 205 this new generation TO_GN is marked NORMAL. Thereafter, in step 206 the new mature generation TO_GN is put last in tospace. An initialization by clearing the copy stack for the combine copy procedure is done in step 207.

In the database of the preferred embodiment a pointer stored in a cell of a generation is directed either to another cell in the same generation or to a cell in an older generation. Therefore, when a generation is collected, all younger, already collected generations must be regarded as the root set to this generation. But scanning all younger generations for pointers to cells in this generation is very expensive. To overcome this, to each major generation to be collected during the major collection an ordered set of addresses of pointers to cells in this generation, named remset (remembered set), is attached. When a cell having a pointer in it directing to an older generation which has not yet been collected is copied, the address of the pointer is added to the remset of the older generation. This includes first generation collections. Remsets are transient and no disk IO is caused from inserting and removing addresses of pointers from remsets. The method and apparatus according to the preferred embodiment is able to reconstruct remsets during a recovery.

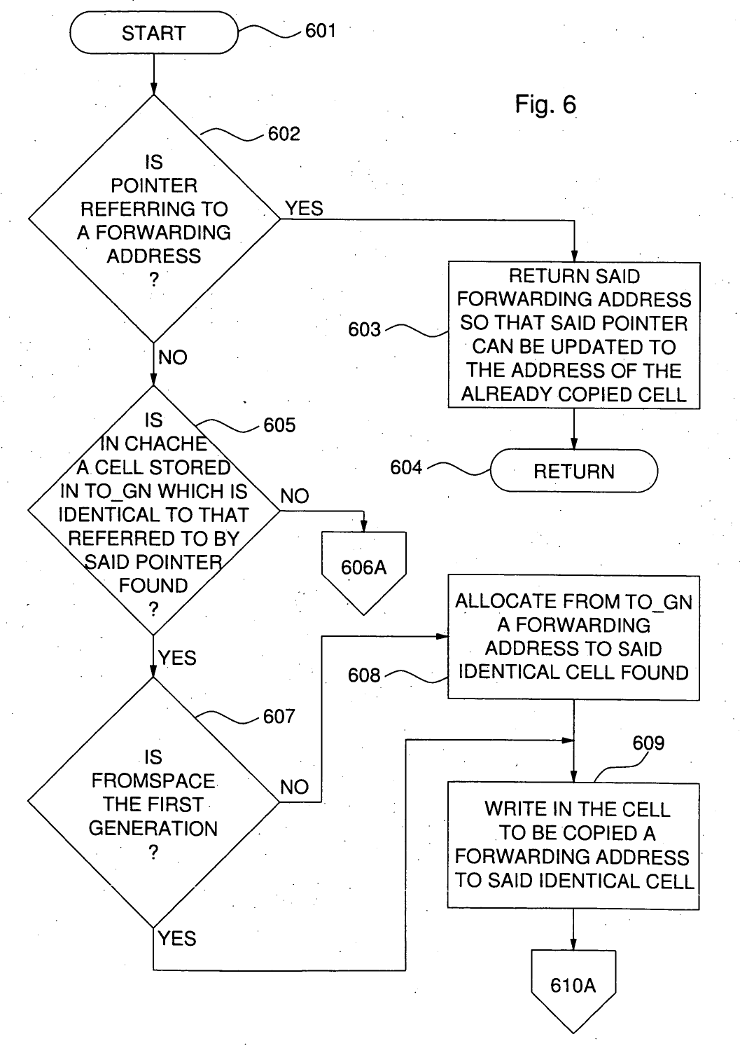

In step 208 the youngest of the generations taken in step 202 is selected and for every address of a pointer which is stored in the remset of this selected generation the cell which is referred to by this pointer is copied according to combine-copy, as described later with reference to FIGS. 6 to 8. Thereafter, said pointer is directed to the new address of the copied cell.

Thereafter, as shown by connectors 209A and 209B, the procedure continues with step 210. If all of the generations taken have been copied by combine-copy according to step 208, then the procedure continues with step 302, as shown by the connector 301A of FIG. 2 and the connector 301B of FIG. 3, else in step 208 the next youngest generation of the generations taken is selected and copied, as formerly described with reference to step 208.

When all cells which are referred to by a pointer stored in a cell are copied in step 208 of FIG. 2, the cells which are referred to by pointers in the root block are copied according to combine copy, and the respective pointer is set to the new address of the copied cell.

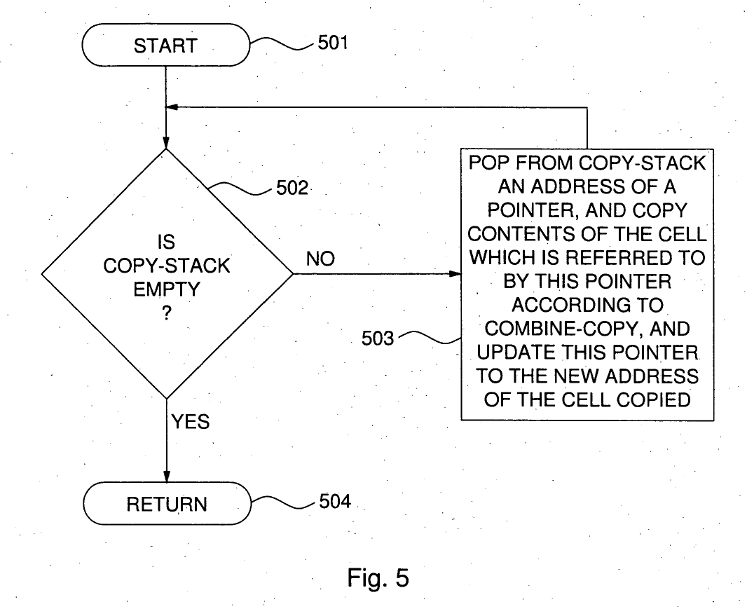

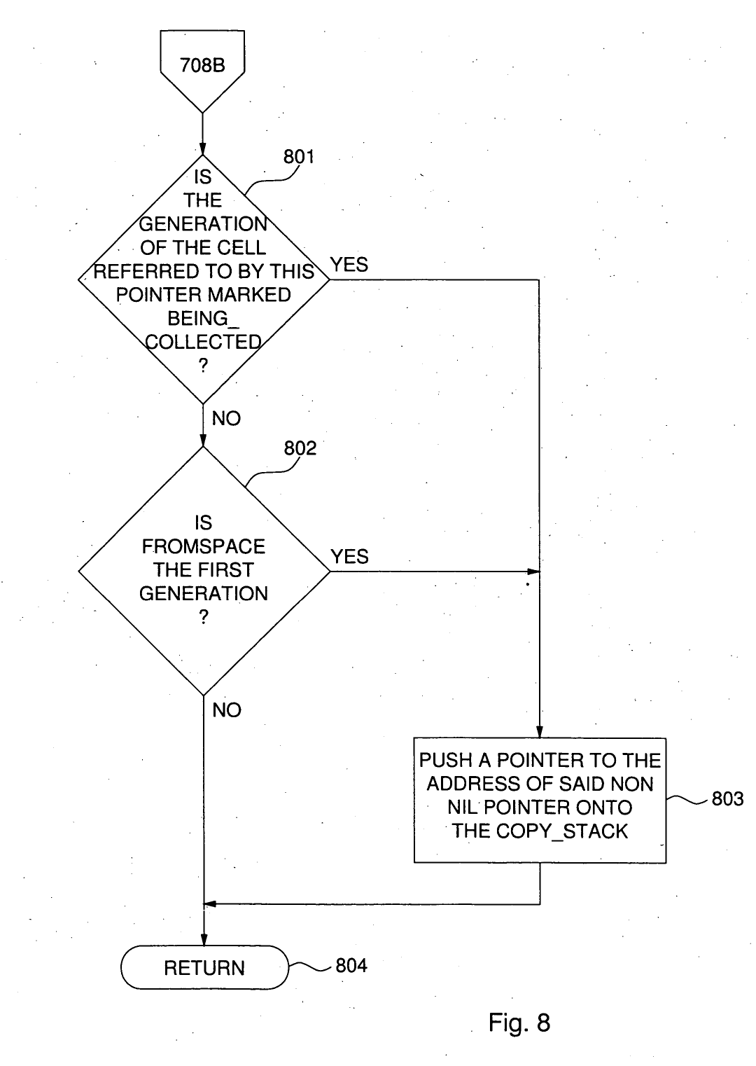

If combine-copy called in steps 208 and 302 has pushed a pointer onto to the copy stack, as described in further detail according to step 803 in FIG. 8, this copy stack is drained in step 303, as described in further detail with reference to FIG. 5.

Thereafter, the youngest generation of the generations taken is selected in step 304, and the pages as well as the remset of the selected generation are freed in steps 305 and 306. Then, the procedure retire-generation is proceeded on the generation selected in step 307. For sake of recovery, generations and their pages on disk are freed only after the completition of the major collection in which they were taken from the fromspace. Therefore, the former fromspace generations are retired to a set of old fromspace generations in the retire-generation procedure called in step 307.

As shown by the connectors 308A and 308B, the procedure continues with step 309, in which it is probed, if another one of the generations taken is left, and if yes, the next one of the generations taken in the order from the youngest to the oldest generation is selected in step 310 and the procedure continues with step 305, as formerly described. On the other hand, if all generations have been selected and therefore no generation is left in step 309, the pages of the new generation TO_GN in which the generations taken have been merged are written to disk in step 311.

After step 311 the major collection step halts in step 312 and the control is given back to the application to process further jobs.

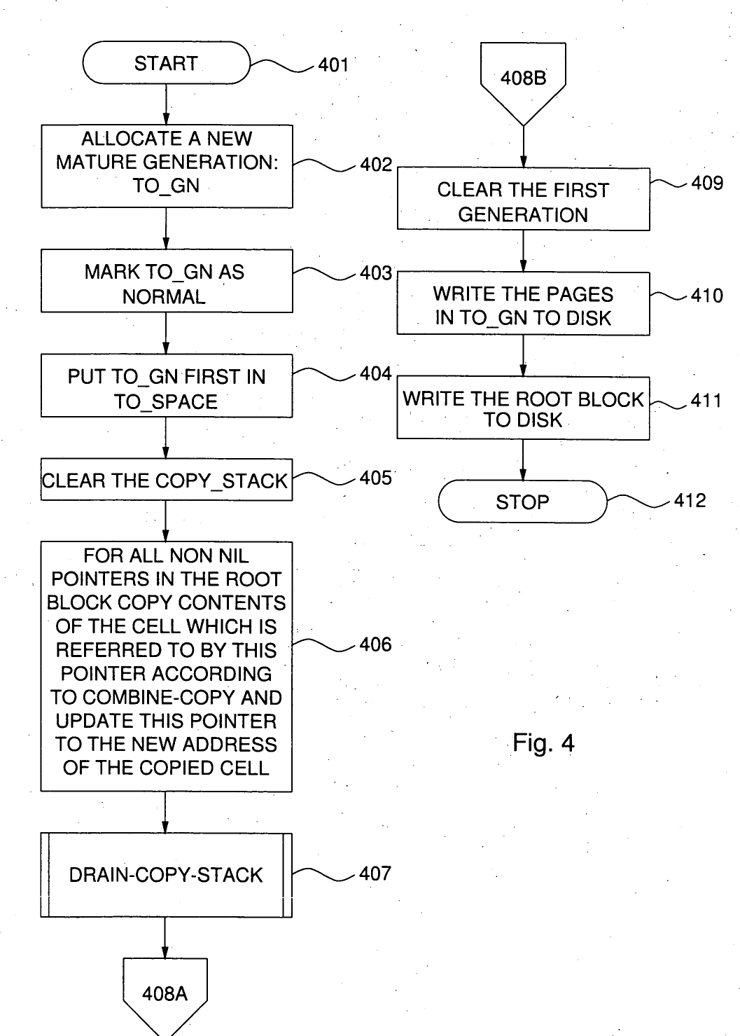

FIG. 4 shows a procedure for collecting a first generation of the database. After starting the first generation collecting procedure with step 401, a new mature generation TO_GN is allocated in the transient memory space in step 402.

Thereafter the new generation TO_GN is marked NORMAL in step 403 and put first in tospace in step 404. Then, in the initialization step 405 the copy stack is cleared. Then, in step 406, for all non-nil pointers in the root block, the cell referred to by such a root block pointer is copied according to combine copy and this pointer is updated to the new address of the copied cell. When step 406 has been finished for all root block pointers, the copy stack is drained in step 407. The copy stack which is used as an auxiliary transient stack during the collection of the first generation of the database to store addresses of pointers to cells which have not yet been copied has a depth of at most the maximum number of cells in the first generation. Since the first generation size is usually also an upper limit to the major generation size, in practice the copy stack need not be very large. The copy stack could also be replaced by any implementation of an ordered multi-set, but a stack is one of the simplest and most efficient.

As shown by connectors 408A and 408B of FIG. 4, after step 407 is finished, the first generation is cleared in step 409. Then, the pages in the generation TO_GN is written to disk in step 410, and finally the root block is written to disk in step 411 before the first generation collection is finished in step 412.

FIG. 5 shows a preferred embodiment of a drain copy stack procedure, which is called, for example, in step 303 of the major collection step procedure and in step 407 of the first generation collection. Hence, both major and minor collection can use the same drain copy stack procedure.

When the drain copy stack procedure is called, after starting in step 501, it probes, if the copy stack is empty or not in step 502. If the copy stack is empty it returns to the main procedure in step 504. When the copy stack is not empty, it pops from the copy stack an address of a pointer, and copies the contents of the cell which is referred to by this pointer according to combine copy in step 503. After copying it also updates this pointer to the new address of the copied cell in step 503. When step 503 is finished, the next address of a pointer is popped from copy stack, until the copy stack is empty, as probed in step 502. Thereby, due to the call of combine copy in step 503, further addresses of pointers can be pushed onto the copy stack, so that these are also processed in the drain copy stack procedure. When all addresses of pointers stored in copy stack have been processed, and hence the copy stack is empty, step 502 finishes the drain copy stack procedure by jumping to step 504, so that the main procedure can be continued.

FIGS. 6, 7 and 8 show a preferred embodiment of the combine copy procedure according to a preferred embodiment of the invention. This combine copy procedure, as now described in further detail, is used, for example, in the major collection step described with reference to FIGS. 2 and 3, in the first generation collection described with reference to FIG. 4 and in the drain copy stack procedure described with reference to FIG. 5. Therefore, the combine copy procedure is called very frequently, so merging of cells is rather efficient.

When combine copied is called, a pointer referring to the cell to be copied is handed over, and the procedure can start in step 601.

To maintain the merging of cells, every time a cell is copied, a forwarding address is stored in this cell, as described in further detail according to steps 609 and 702, hence combine copy first checks, if that pointer is referring to a forwarding address in step 602. When that pointer is referring to a forwarding address combine copy returns that forwarding address in steps 603 and 604, so that that pointer can be updated to the address of the already copied cell.

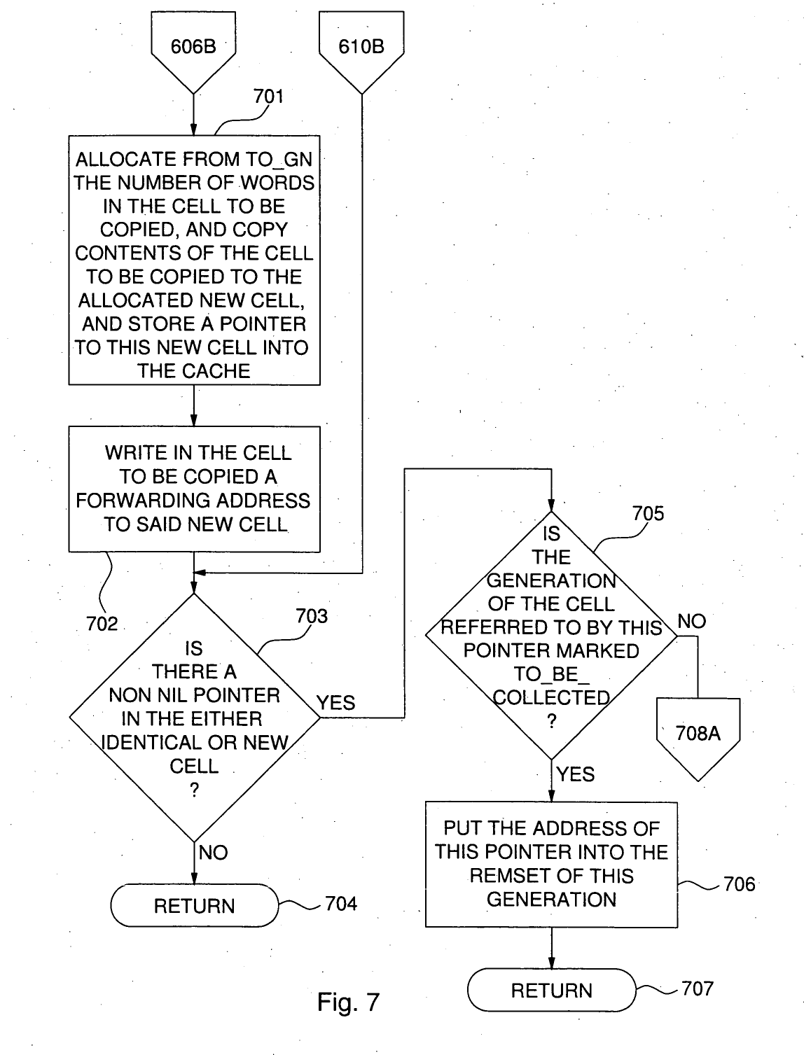

When that pointer is referring to a cell which has not been copied before, it is probed in step 605, whether in cache a cell identical to the cell referred to by said pointer is stored. And if such an identical cell is found and also stored in the same generation TO_GN as the cell should be copied to, combine copy proceeds with step 607. Otherwise, as shown by the connector 606A of FIG. 6 and the connector 606B of FIG. 7, combine copy allocates from the generation TO_GN the number of words in the cell to be copied, and copies the contents of the cell referred to by said pointer to the allocated new cell, and stores a pointer to this new cell into the cache. Hence, if another cell identical to that cell copied is found in cache, by a further call of combine copy, this cell can be merged with that copied cell. If the cell copied is already a merged cell, to maintain this merging in step 702 in the cell copied a forwarding address to that new cell allocated is stored.

In case combine copy proceeds with step 607, the cell to be copied is merged with said found identical cell stored in the same generation. Therefore, the address of the found cell is returned by combine copy in step 704, 707 or 804, so that said pointer handed over to combine copy at starting step 601 can be updated to the address of the found identical cell. However, combine copy takes care that, for example due to a power failure, combined cells can be correctly recovered. If the combined cell is simply omitted from the generation TO_GN and its place is taken by another cell, then the recovery procedure does not know it should redirect references to the omitted cell to the combined one. Hence, if fromspace is the first generation, as checked in step 607, in step 608 a forwarding address to said identical cell found is allocated from TO_GN. After the garbage collection is completed the forwarding pointer should no longer be referred to and it will therefore be collected away in the next garbage collection round. Such forwarding pointers are not needed during first generation garbage collection, since the only references to the surviving cells are from the root block, which is written to disk with its pointers referring directly to the combined cells, so in this case step 608 is omitted and step 607 is succeeded by step 609.

Step 609 preceded by step 607 and step 608, writes in the cell to be copied and referred to by said pointer a forwarding address to said identical cell found, so that, in case the cell- to be copied is already a merged cell, this merging is maintained, when this cell is copied again by combined copy due to another pointer referring to it.

Both step 609, as shown by connector 610A of FIG. 6 and connector 610B of FIG. 7, and step 702 of FIG. 7 are succeeded by step 703. When there is a non-nil pointer in the either identical (steps 607, 608 and 609) or new (steps 701 and 702) cell, as probed in step 703, step 705 follows, else the address of the either identical or new cell is returned to the procedure which called combine copy so that said pointer can be updated to the address of the identical or new cell, and combine copy is finished.

In case the application continues with step 705 and the generation of the cell referred to by the pointer found in step 703 is marked TO_BE_COLLECTED, the address of this pointer is added to the remset of this marked generation in step 706, and thereafter the address of the either identical or new cell is returned in step 707, as formerly described with reference to step 704, and the combine copy procedure is finished. Otherwise, as shown by connector 708A of FIG. 7 and connector 708B of FIG. 8, combine copy is continued with step 801. In case the generation of the cell referred to by the non-nil pointer found in step 703 is marked BEING_COLLECTED, as probed in step 801, or fromspace is the first generation, as probed in step 802, a pointer to the address of said non-nil pointer is pushed onto the copy stack in step 803. If neither the generation of the cell referred to by said pointer is marked BEING_COLLECTED nor from space is the first generation, step 803 is omitted. However, in both cases the address of the either identical or new cell is returned in step 804 and combine copy is finished, as previously described with reference to step 704.

Notice in step 605 of the preferred embodiment of combine copy the restriction that implies that said combining does not occur over generation boundaries. It is also possible to alleviate this restriction so that the identical cell found can also be in an older generation than the cell to be copied. This requires the remset of the generation of the identical cell to be updated accordingly.

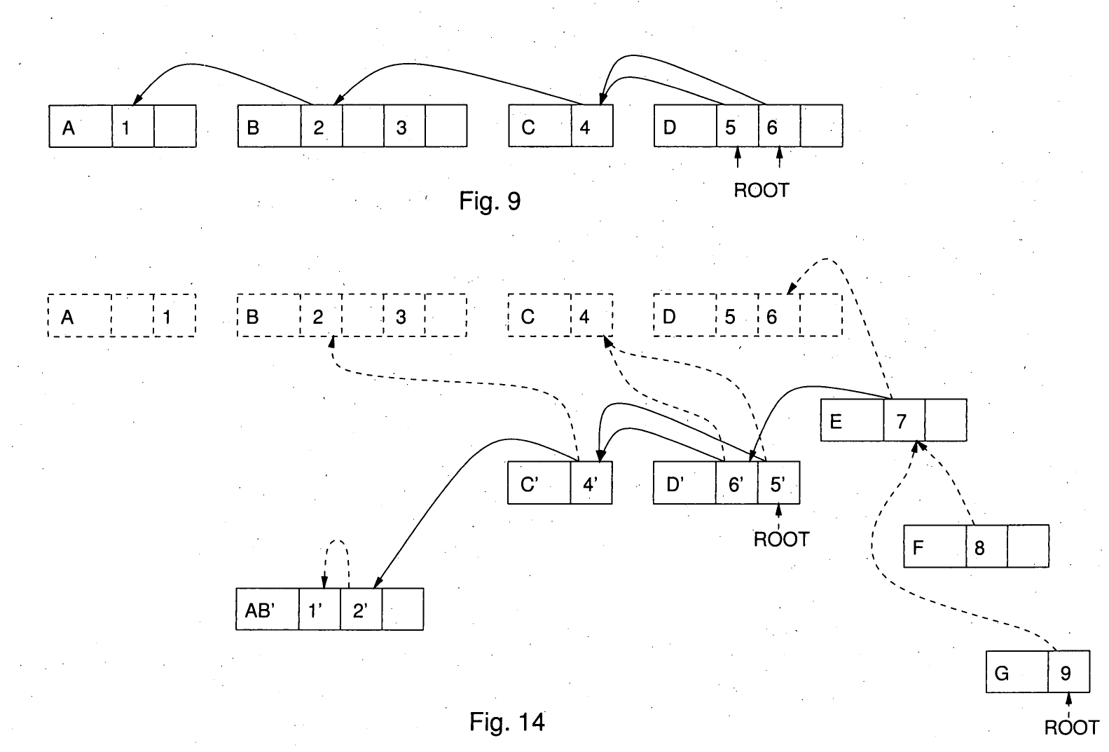

A first example of a database during a major generation garbage collection is now described with reference to FIG. 9 to 13. Generations can contain thousand or more cells, but for simplicity in the first example each generation only contains a few cells. As shown in FIG. 9, generation A contains a cell 1, generation B contains cells 2 and 3, generation C contains cell 4 and generation D contains cells 5 and 6. Generations A, B and D contain some further cells which are not explicitly referred. Solid lines with arrows at the end show pointers directing to cells. Cells 5 and 6 of generation D are referred to by root block pointers stored in the root block of the database. In both cells 5 and 6 of generation D a pointer to cell 4 of generation C is stored. Also, in cell 4 a pointer to cell 2 of generation B, and in this a pointer of cell 1 of generation A are stored. Cell 3 of generation B is garbage, because it is not referred to by any pointer.

In the beginning of a major collection, all generations A, B, C, D are marked TO_BE_COLLECTED (step 102, FIG. 1) and put into the from space list (step 103) by the major collection begin procedure.

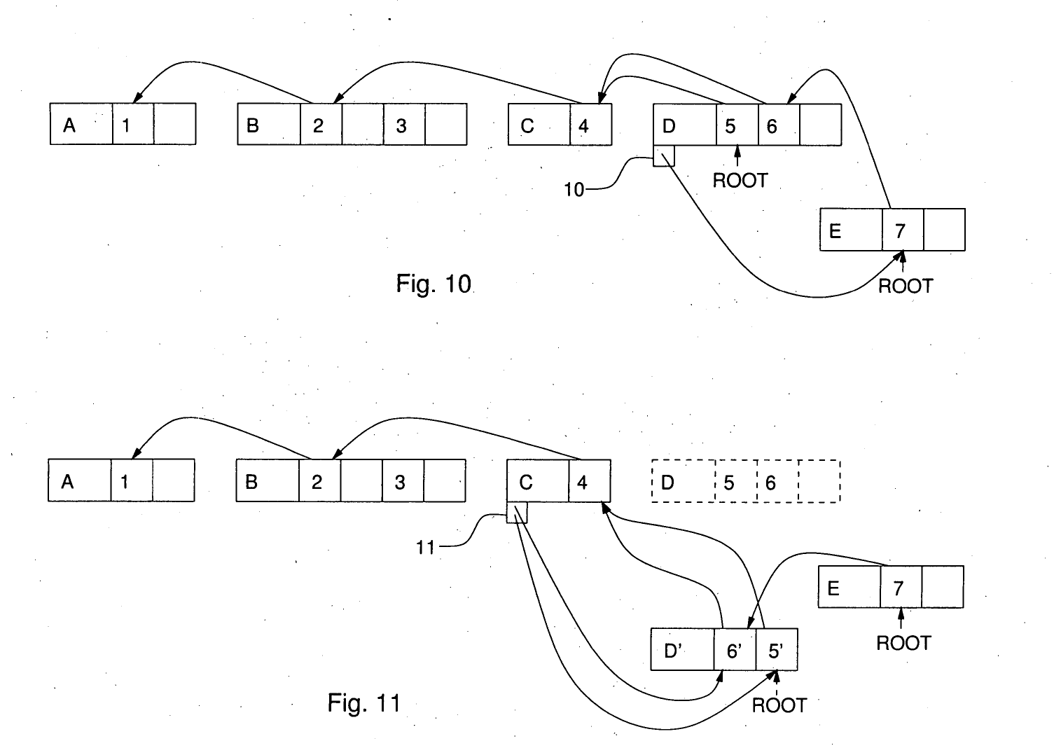

In FIG. 10 a first generation is collected and it becomes the new youngest major generation E, and the generation E contains a cell 7 which refers to cell 6 in generation D. Thereby, cell 7 is copied into generation E by step 701 of combine copy, as shown in FIG. 7. Cell 7 contains a non-nil pointer to cell 6 of generation D, and since generation D is marked TO_BE_COLLECTED combine copy inserts the address of the pointer from cell 7 to cell 6 into the remset 10 of generation D in step 706.

As shown in FIG. 11, due to a time count or the like the major generation D is collected. The tospace major generation of D is referred to by D′ and cells are marked correspondingly. This collection is done by the major collection step procedure, as formerly described with reference to FIGS. 2 and 3. Cell 6 is copied to cell 6′, because it is referred to by a pointer whose address is stored in the remset 10 of the generation D (step 208), and cell 5 is copied because a root pointer refers to it (step 302). After copying cells from the generation D into the generation D′, the pages occupied by the generation D are returned to the pool of free pages (steps 305, 306 and 307). Thereby, the pointer from cell 7 to cell 6 is updated in place to refer to the copied cell 6′ in step 208.

While copying cells 5 and 6 into generation D′, since generation C is marked TO_BE_COLLECTED, as probed in step 705, the addresses of the pointers from cell 6′ to 4 and 5′ to 4 are put into the remset 11 of generation C in step 706.

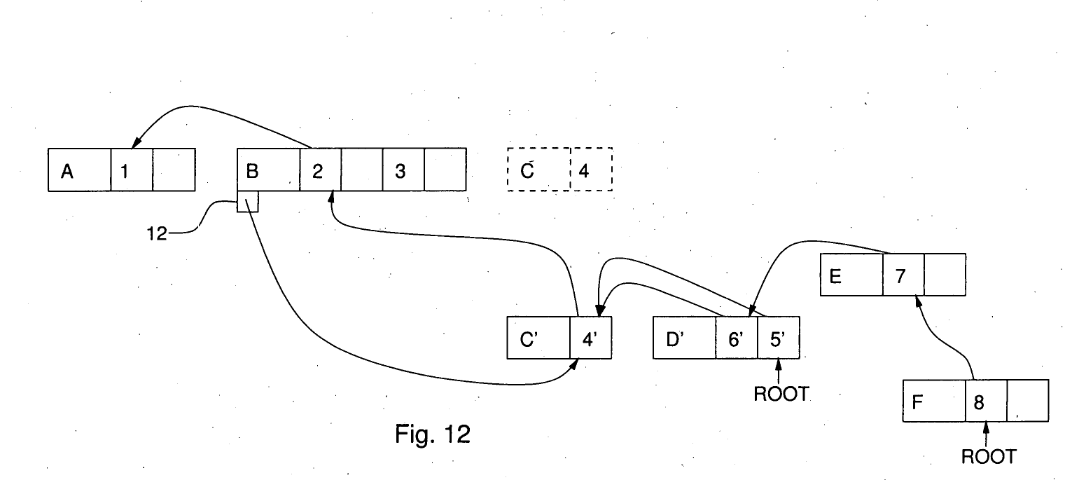

Due to a pressing need for more free pages or for another reason, the generation C is collected to a second major generation C′ before returning control to the application, as shown in FIG. 12. Cell 4 of generation C is copied to cell 4′ of generation C′, because addresses of the pointers from 6′ and 5′ belong to the remset 11 (FIG. 11) of generation C. Thereby, when handling the pointer from 5′ to 4, the forwarding address from 4 to 4′ was used in step 603 of combine copy. This forwarding address was stored in cell 4 in step 702 after combine copy copied cell 4 according to the reference of the pointer from cell 6′ in step 701. Further, the address of the pointer from cell 4′ of cell 2 of the generation B is added to the remset 12 of the generation B in step 706, because the generation B is marked TO_BE_COLLECTED. Further, after copying cells from generation C to generation C′, the pages occupied by generation C are returned to the pool of free pages (steps 305, 306, 307).

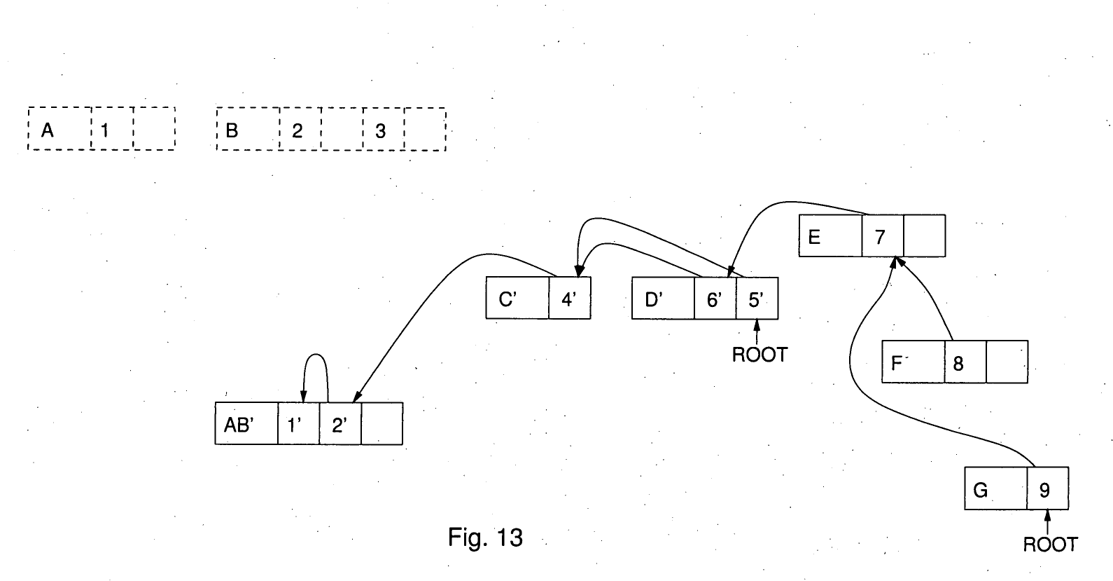

After the application has run for a while, the first generation collection occurs and the new major generation F having a cell 8 appears. Since the mark of generation E is NORMAL, the remset of generation E is left empty even if cell 8 in generation F refers to cell 7 in generation E. Also the generations C′ and D′ are marked NORMAL and the generations A and B are still marked TO_BE_COLLECTED. Next, the major collection step procedure is performed on generations A and B to merge this generations into AB′, as shown in FIG. 13. Said generations A and B are taken together in step 202, and therefore they are both marked as BEING_COLLECTED in step 203. Hence, combine copy takes in step 705 the way through connectors 708A and 708B and is pushing the pointer to the address of the pointer from cell 2′ to cell 1 onto the copy stack in step 803. And by draining the copy stack in step 303 cell 1 is copied to cell 1′ in step 503 without remsets.

Hence pointers from generation B to generation A can be treated without remsets, as if they were normal intra-generation pointers. The major collection is now finished. In the final picture, shown in FIG. 13, a new major generation G has appeared after some application processing, and the pages of generations A and B have been freed.

While the application is not allowed to mutate cells once they have been collected to major generations and written to disk, the major collection step procedure does exactly this in step 208 when traversing the remset by updating the pointer to the new address of the copied cell. The mutated pages must not be re-written to disk and there are no logs or similar structures on disk of these mutations necessary, still the new page can be reconstructed during a recovery.

With reference to FIG. 14 the recovery of the first example of the database is illustrated, when a major collection has been completed before the crash. In FIG. 14 dashed lines show pointer values on disk pages and solid lines show how they were redirected in main memory after the pages (of the cells) were written to disk. Pointers from or within the generations A, B, C and D are not shown since they are not used during the recovery.

The recovery procedure starts by creating into memory the pages of the generations in the original fromspace, i.e. the generations A, B, C and D. These generations are marked TO_BE_COLLECTED and inserted into the fromspace. The cells in these generations need not be read from disk; the fromspace is used only to store forward pointers during recovery.

Next, the pages of generation E are read from disk and scanned by a recovery procedure. Since there is a pointer from cell 7 to a generation marked TO_BE_CONNECTED, the address of that pointer is added to the remset of generation D. The generation E and the remset of generation D are now identical to what they were before collecting the generation D before the crash. Hence, the generation D′ is read from disk and the pointers from cell 7 to the cell 6 is redirected to the cell 6′. Then generation D′ is scanned for pointers to older generations and the remsets of that older generations are updated as if during normal major collection. Finally the pages of generation D are freed.

The next steps in recovery are the recovery of generations C′, F, AB′ and finally G.

In the database of the first example, when a page becomes full, a new empty page is taken from the pool of free pages and added to the generation serving as the tospace. Additionally, the cells of each page are counted, so that all cells of the generation can be enumerated in the order they were allocated in the generation. This property is used in the recovery procedure. In the drawings the pages are omitted since they would clutter the pictures; instead the generations are shown as varisized contiguous areas of memory.

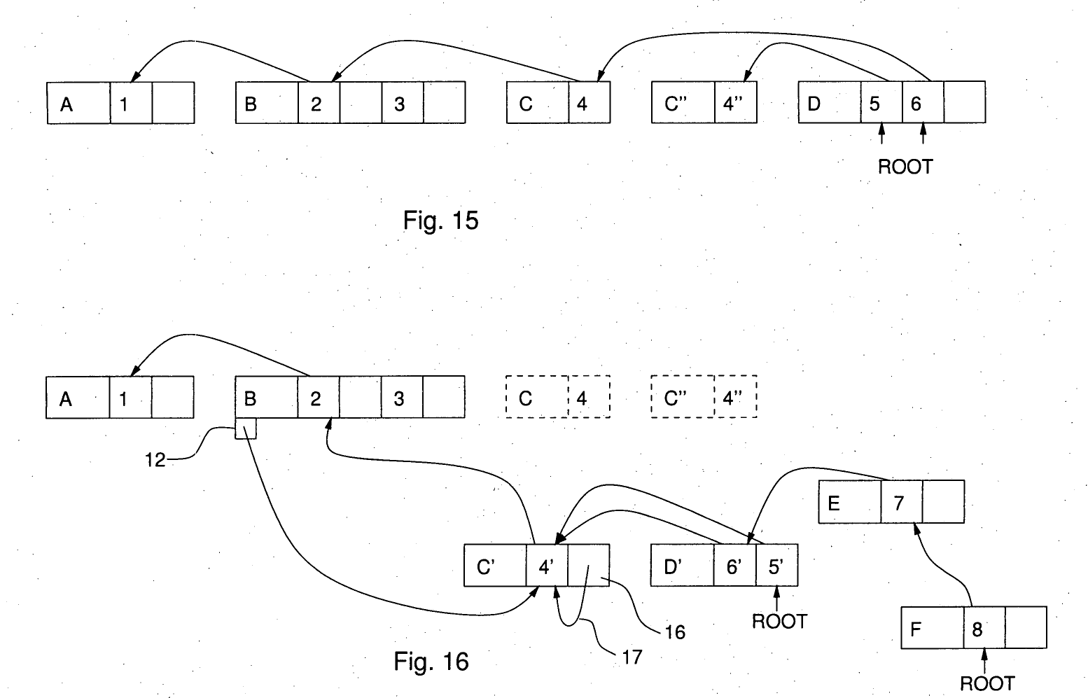

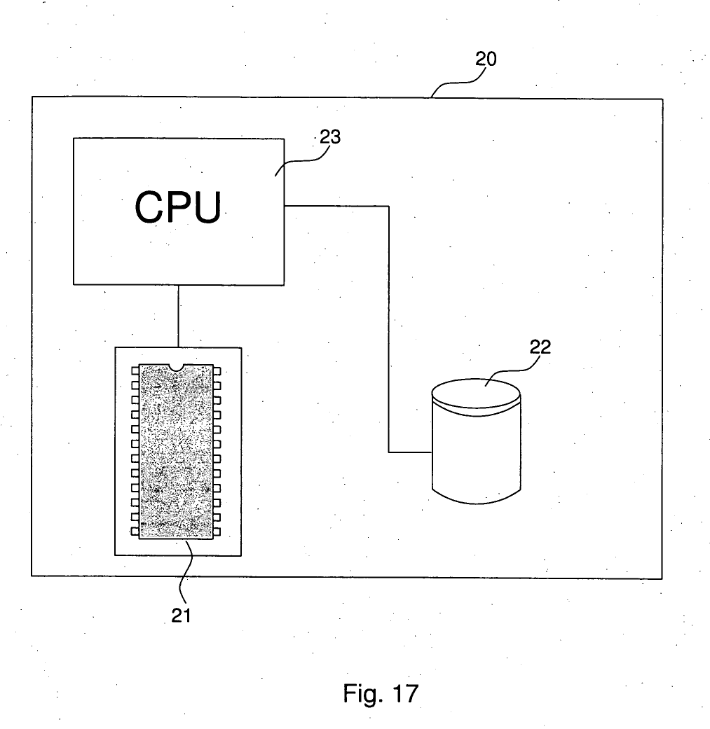

FIGS. 15 and 16 show a second example of a database. Formally described elements are referred to by the same reference numeral.

The database of the second example differs from the database of the first example, as shown in FIG. 9, in that way, that it comprises an additional generation C″ having a cell 4″. The contents of cell 4 of generation C and cell 4″ of generation C″ are identical. Also the pointer from cell 5 of generation D instead of referring to cell 4, as shown in FIG. 9, refers to cell 4″ of generation C″.

In the beginning of a major collection, the generations A, B, C, C″ and D are marked TO_BE_COLLECTED in step 102. After generation D has been collected, a pointer to cell 6 of generation D′ has been added to the remset (not shown) of the generation C and a pointer to cell 5′ of generation D′ has been added to the remset (not shown) of generation C″.

Next, as shown in FIG. 16, both generations C and C″ are collected in a further major collection step into the new major generation C′. Since generation C″ is the youngest of the generations taken step 208 of the major collection step procedure copies the contents of cell 4″ into the cell 4′ of generation C′ according to combine copy. Thereby, combine copy allocates in step 701 the number of words in the cell 4″ to be copied from the generation C′, and copies the contents of the cell 4″ to the allocated new cell 4′, and stores a pointer to the new cell 4′ into the cache. Thereafter, the major collection step procedure copies the contents of cell 4 of generation C in step 208, because the address of pointer 6′ of generation D′ is stored in the remset of generation C. Hence, combine copy is called again, and finds in step 605 the cell 4′ stored in the generation C′ which is identical to that cell 4 which is referred to by the pointer from 6′. Since from space is not the first generation, from generation C′ a forwarding address 16 to said identical cell 4′ found is allocated. This forwarding address 16 refers to cell 4′, as shown by pointer 17, and is stored in generation C′.

Since cell 4′ refers to a cell in generation B, the address of cell 4′ is stored in the remset 12 of generation B.

The forwarding address 16 to said identical cell 4′ is used by the recovery procedure, as described previously.

FIG. 13 shows a preferred embodiment of an apparatus 20 for storing and processing a database. The apparatus 20 comprises a transient memory space, such as an dynamic random access memory (DRAM) and is connected to a persistent memory space, such as a disk storage 22. A central processing unit 23 of the apparatus 20 has access to the DRAM 21 and the disk storage 22. The persistent data described is stored onto the disk storage 22 and can be loaded into the DRAM 21 by the central processing unit 23. The processes described are processed by the central processing unit 23.

Although exemplary embodiments of the invention have been disclosed, it will be apparent to those skilled in the art that various changes and modifications can be made which will achieve some of the advantages of the invention without departing from the spirit and scope of the invention, such modifications to the inventive concept are intended to be covered by the appended claims.

1. A method for copying cells in a database which are referred to by pointers, whereby said cells are arranged in at least one generation, each generation comprising at least one cell, said method comprising the steps of:
a) probe if a cell identical to a cell to be copied is stored in a cache memory,
b) if such an identical cell is found in said cache instead of copying the content of the cell, redirecting the pointer referring to said cell to be copied to said identical cell, and
c) performing a garbage collection onto at least one generation of the database in which only cells referred to by at least one pointer are collected into a new generation.

2. A method according to claim 1, wherein in case an identical cell is found in said cache, from the space cells are copied to, a forwarding address to said identical cell is allocated.

3. A method according to claim 2, wherein pointers referring to cells are stored in a fast accessible transient memory.

4. A method according to claim 3, wherein pointers to cells which are redirected are temporarily stored only in said transient memory.

5. A method according to claim 3, wherein at least one generation of the database is marked to be collected, and
said redirected pointers are stored in a persistent memory after the generations marked have been collected.

6. A method according to claim 5, wherein said persistent memory is a disk storage.

7. A method according to claim 3, wherein said transient memory is a dynamic random access memory.

8. A method according to claim 1, wherein said cache is stored in a transient memory.

9. A method according to claim 8, wherein said transient memory in which said cache is stored is a dynamic random access memory.

10. A method according to claim 1, wherein said cache in which the contents of at least a few copied cells are stored in a hash table.

11. A method according to claim 10, wherein said contents are stored as a hash code, and in case that a cell having an identical hash code as said cell to be copied is found, the content of said cell found and the content of said cell to be copied are compared.

12. A method according to claim 1, wherein, if the content of a cell is copied to a new cell, a forwarding address to the new cell is stored in said cell copied, and
if a cell, because being referred to by a further pointer, is copied in which a forwarding address is stored, instead of copying the content of said cell, said further pointer referring to said cell is updated to the forwarding address.

13. An apparatus for storing and processing a data base comprising:
a persistent memory for storing at least one generation of the database, whereby each generation comprises at least one cell and a cell of one of the generations can be copied into a new mature generation, said persistent memory is also storing the pointers stored in the cells of the mature generations of the database, and the pointers stored in the root block of the data base,
a transient memory for storing copies of pointers referring to the cells of the generations of the database, whereby those pointers are temporarily updated only in the transient memory,
characterized by
a cache stored in said transient memory in which at least a few of the cells are stored which have been recently copied,
whereby, in case a cell of one of the generations is copied into a new mature generation, it is probed if a cell which is identical to said cell to be copied is stored in said cache, and if such an identical call is found in cache, the pointer referring to said cell to be copied is redirected to the address of said identical cell, and
a forwarding address from the new mature generation to said identical cell is allocated.

14. An apparatus for storing an processing a database according to claim 13, characterized in that said transient memory is a dynamic random access memory.

15. An apparatus for storing an processing a database according to claim 13, characterized in that said persistent memory is a disk storage.

16. An apparatus for storing and processing a database according to claim 13, characterized in that said cache is a hash table.

17. An apparatus for storing and processing a database according to claim 13, characterized in that, in case the content of a cell of a generation is copied to a new cell of the new mature generation, a forwarding address is stored in the cell copied, and,
if according to a further pointer this cell is copied again, said further pointer is updated to the address stored.
